(19) United States
(12) Patent Application Publication
(10) Pub. No.: US 2025/0387693 A1
(43) Pub. Date: Dec. 25, 2025

(54) Playing Card Board Game

(71) Applicants: JEFF FOSTER, Lake Oswego, OR (US); Mark Ebsen, West Linn, OR (US); Ed Swartz, Portland, OR (US)

(72) Inventors: JEFF FOSTER, Lake Oswego, OR (US); Mark Ebsen, West Linn, OR (US); Ed Swartz, Portland, OR (US)

(21) Appl. No.: 19/305,752

(22) Filed: Aug. 20, 2025

Related U.S. Application Data
(62) Division of application No. 17/685,354, filed on Mar. 2, 2022.

(51) Int. Cl. A63F 1/04; A63F 1/00; A63F 3/00; A63F 11/00

(52) U.S. Cl. CPC A63F 1/04; A63F 3/00157; A63F 3/00261; A63F 11/0074; A63F 2001/005; A63F 2003/00268; A63F 2011/0086

(57) ABSTRACT

A novel design for a hybrid playing card and board game of cribbage and poker that can accommodate up to eight players individually or in teams. The game may be played physically with other players at a brick and mortar location, as well as virtually with remote players via an application available through an internet gaming site. The rules of cribbage and of poker are retained along with minor player options for enhanced betting. A specific circular game board tailored for betting in physical play, and having expansion capabilities is used.

### COPYRIGHT STATEMENT

A portion of the disclosure of this patent document contains material that is subject to copyright protection. The copyright owners have no objection to the facsimile reproduction by anyone of the patent drawings or the patent disclosure as it appears in the Patent and Trademark Office patent file or records, but otherwise reserves all copyright rights whatsoever.

### FIELD

The present disclosure relates, in general, to playing card games, and more particularly to a card and board game that is optimally designed for both gambling and pure enjoyment and can be easily adapted for online gaming applications.

### BACKGROUND

Certain playing card games like Poker are more suited for gambling than other card games such as Cribbage. That is not to say that one cannot gamble on the point spread or skunk lines in a Cribbage game, it just means that some card games do not have multiple chances to bet between hands and as a result, do not offer the excitement that serious gamblers seek. Certain card games are more chance based with limited options for winning beyond the hand dealt. Other card games are more cerebral and winning is based more on the way the hand is played than what is dealt. An ideal blend of card games would be the merge of two games that would allow the player to shift or play the cards in the hand they were dealt, to either of the games so as to financially benefit them the most. Such a game would add the complexity of not only both the card games, but also the complexity of watching and reacting to the overall scoring. The players can be strong in either or both of the card games, adjusting their play as necessary to accumulate the most points or to accumulate the Poker betting referred to as the POT.

For internet play, many gambling card games transition well to “live” play against other players that are also remotely sitting in the same game but do not transition well to play against a computer program with preset rules and decision making.

Henceforth, a card game that combines two simple and well understood card games into one game having an increased complexity, that allows hand by hand betting in an equally satisfying “live” or computer play situation, would fulfill a long felt need in the gaming industry. This new invention utilizes and combines known and new rules in a unique and novel configuration to overcome the aforementioned problems and accomplish this.

### BRIEF SUMMARY

In accordance with various embodiments, a hybrid playing card/board game of five card Poker and Cribbage is provided.

In one aspect, a hybrid playing card game optimized for both “live” and computer virtual play in a gambling or non-gambling mode is provided.

In another aspect, a hybrid playing card/board game of Poker and Cribbage having a board designed for score keeping of the Cribbage aspect as well as the collection and retrieval of gambling tokens/chips is provided.

Various modifications and additions can be made to the embodiments discussed without departing from the scope of the invention. For example, while the embodiments described above refer to particular features, the scope of this invention also includes embodiments having different combination of features and embodiments that do not include all of the above described features.

### BRIEF DESCRIPTION OF THE DRAWINGS

A further understanding of the nature and advantages of particular embodiments may be realized by reference to the remaining portions of the specification and the drawings, in which like reference numerals are used to refer to similar components.

FIG. 1 is an exploded perspective view of the Croker game board;

FIG. 2 is a top view of the Croker game board;

FIG. 3 is a cross sectional view of the Croker game board;

FIG. 4 is a cross sectional view of the base of the Croker game board;

FIG. 5 is a perspective view of the components of the Croker game; and

FIGS. 6 to 14 are perspective views of nine sequential stages of play in a game of Croker.

### DETAILED DESCRIPTION OF CERTAIN EMBODIMENTS

While various aspects and features of certain embodiments have been summarized above, the following detailed description illustrates a few exemplary embodiments in further detail to enable one skilled in the art to practice such embodiments. The described examples are provided for illustrative purposes and are not intended to limit the scope of the invention.

Reference will now be made in detail to embodiments of the inventive concept, examples of which are illustrated in the accompanying drawings. The accompanying drawings are not necessarily drawn to scale. In the following detailed description, numerous specific details are set forth to enable a thorough understanding of the inventive concept. It should be understood, however, that persons having ordinary skill in the art may practice the inventive concept without these specific details.

It will be understood that, although the terms first, second, etc. may be used herein to describe various elements, these elements should not be limited by these terms. These terms are only used to distinguish one element from another. For example, a first attachment could be termed a second attachment, and, similarly, a second attachment could be termed a first attachment, without departing from the scope of the inventive concept.

It will be understood that when an element or layer is referred to as being “on,” “coupled to,” or “connected to” another element or layer, it can be directly on, directly coupled to or directly connected to the other element or layer, or intervening elements or layers may be present. In contrast, when an element is referred to as being “directly on,” “directly coupled to,” or “directly connected to” another element or layer, there are no intervening elements or layers present. Like numbers refer to like elements throughout. As used herein, the term “and/or” includes any and all combinations of one or more of the associated listed items.

The terminology used in the description of the inventive concept herein is for the purpose of describing particular embodiments only and is not intended to be limiting of the inventive concept. As used in the description of the inventive concept and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

In the following description, for the purposes of explanation, numerous specific details are set forth in order to provide a thorough understanding of the described embodiments. It will be apparent to one skilled in the art, however, that other embodiments of the present invention may be practiced without some of these specific details. It should be appreciated that the features described with respect to one embodiment may be incorporated with other embodiments as well. By the same token, however, no single feature or features of any described embodiment should be considered essential to every embodiment of the invention, as other embodiments of the invention may omit such features.

Unless otherwise indicated, all numbers herein used to express quantities, dimensions, and so forth, should be understood as being modified in all instances by the term “about.” In this application, the use of the singular includes the plural unless specifically stated otherwise, and use of the terms “and” and “or” means “and/or” unless otherwise indicated. Moreover, the use of the term “including,” as well as other forms, such as “includes” and “included,” should be considered non-exclusive. Also, terms such as “element” or “component” encompass both elements and components comprising one unit and elements and components that comprise more than one unit, unless specifically stated otherwise.

As used herein, the term “CROKER” refers to a playing card/board game that is a hybrid of the games of five card Poker and Cribbage and follows all the rules of each.

As used herein, the term “betting chips” refers to any form of money or token representing a specific denomination of currency used in the process of betting.

As used herein, the term “POT” refers to the amalgamated amount of money bet by the players in each hand of a card game and to be dispersed based on the best outcome of that hand.

As used herein, the term “deck of playing cards” or “playing cards” means a conventional deck of 52 cards ranging from two to Ace in value and in the four suits of clubs, spades, diamonds and hearts, with optional jokers. The term “playing cards” and “cards” are interchangeably used herein.

As used herein. The term “set of Poker rules” and “set of Cribbage rules” refer to the official rules of these respective games of cards whether in a printed bound form rulebook or in common knowledge. The term “set of Croker rules” refer to the rules for merging the two games of Poker and Cribbage together, governing the order of play, the use of the CRIB and the betting protocol for Poker and for Cribbage.

As used herein, the term “betting currency” means all forms of betting chips and tokens as well as paper and coin currency and miscellaneous valuable goods that are bet on the outcome of a hand of CROKER.

As used herein, the term “anteing” means placing a financial stake represented by money or a physical token representing a financial value, into the pot for betting.

The present invention relates to a novel design for a hybrid playing card and board game of Cribbage and five card Poker that can accommodate up to eight players individually or in teams. The game is called “CROKER” herein. The game CROKER may be played physically with the other players at a brick and mortar location, as well as virtually on an application available via an internet gaming site. A specific board tailored to betting in physical play and for expansion for larger player games is provided and detailed herein.

The novel features of creating a hybrid between five card Poker and Cribbage is that the decision of which of the player's five cards to keep is not based on the best Poker hand or on the best Cribbage hand. Rather, it is based on which hand will best further the goal of winning the most money at the end of the game. Depending on the POT, a player may choose to discard a card that helps the Cribbage hand in favor of a better Poker hand. Or, a payer may choose to discard a card that makes a good Poker hand in favor of a better Cribbage hand. Winning the Cribbage game and/or skunking the opponents may be a better game value (garner more winnings) then focusing on the Poker hand, depending if the POT is worth pursuing.

In CROKER the rules of Cribbage and the rules of Poker are not altered. Cribbage rules remain as outlined with the American Cribbage Congress (ACC) and United Kingdom Cribbage Association (UKCA). Poker rules, card ranking and other formalities that are obvious in the field of Poker, and set forth in Robert's Rules of Poker, remain the same, however, players will need to agree to as to the type of Poker and the options on Poker play as these are different for the different types of five card Poker. For example: five card high hand; or, five card Jack's or better to win; or, five card low ball, lowest hand wins; or, five card high hand with a wild card; or, Joker(s) (if chosen to include in the deck) as a wild card; and so forth. For the purpose disclosing this invention, the preferred method of the Poker play is five card high hand. CROKER has its own set of rules that govern the order of play, the use of the CRIB for the Poker hands of the game, and the betting protocols for both Poker and Cribbage.

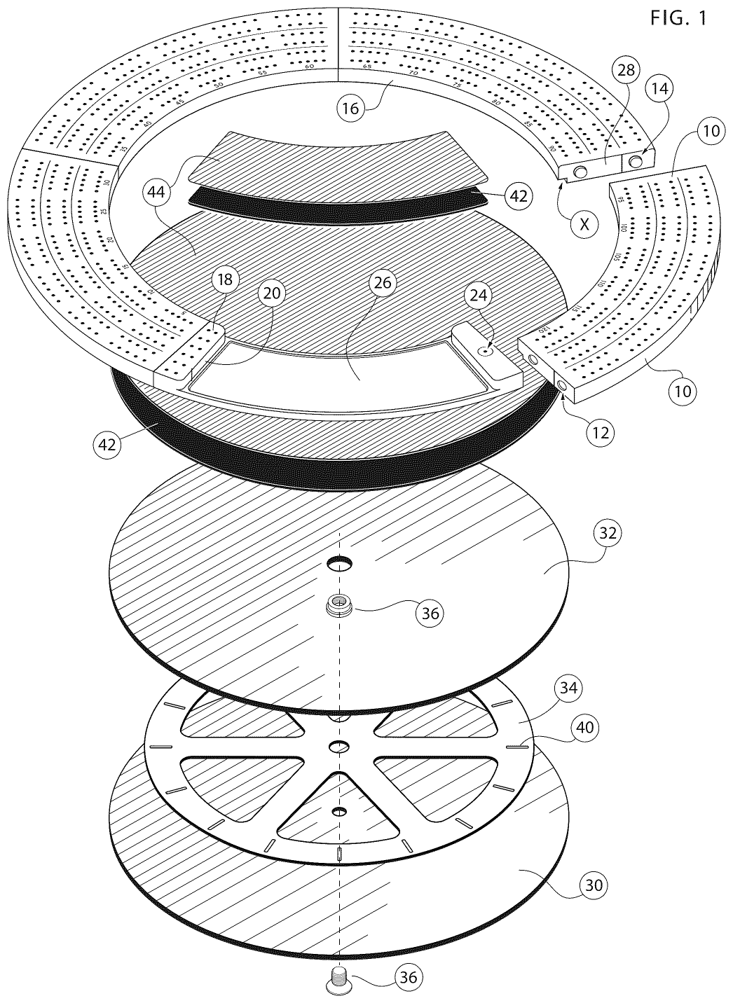

Looking at the CROKER game board (“board”) as illustrated in FIGS. 1-4, it can be seen that the board 2 is made of an upper pegging ring 4 coupled to a bottom rotatable platter 6. The pegging ring 4 has an open geometric shape, preferably an open circle or a “C” configuration as this is the best aesthetically and also the best suited for rotation about a platter set on the playing table. However, other open geometric shapes may be utilized such as ovals, triangles, rectangles or polygons with equivalent results.

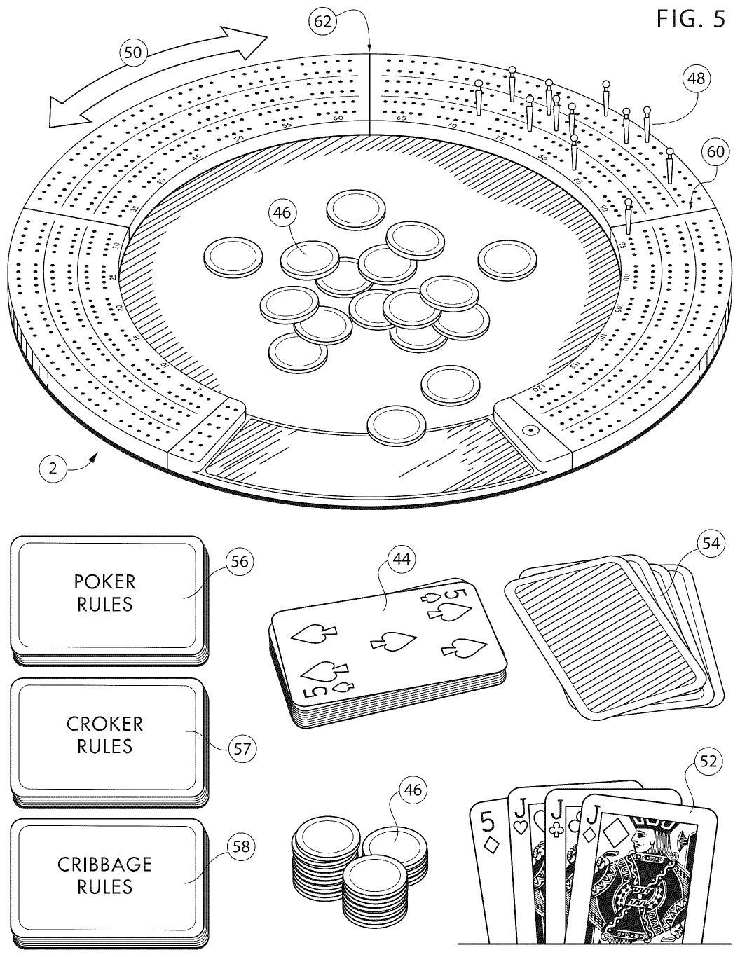

The concept behind the design of the board is that betting currency can be tossed into the center of the board and not bounce out because of the padded felt covering, and the open periphery of the board allows the winner of a played hand to rotate the board (seen as direction arrow 50 in FIG. 5) with its open periphery towards them and then rake the winnings out of the center of the board and onto the table in front of them. The rotatable nature of the board also allows players to rotate the board when pegging Cribbage hands rather than to have to stand and reach over the board.

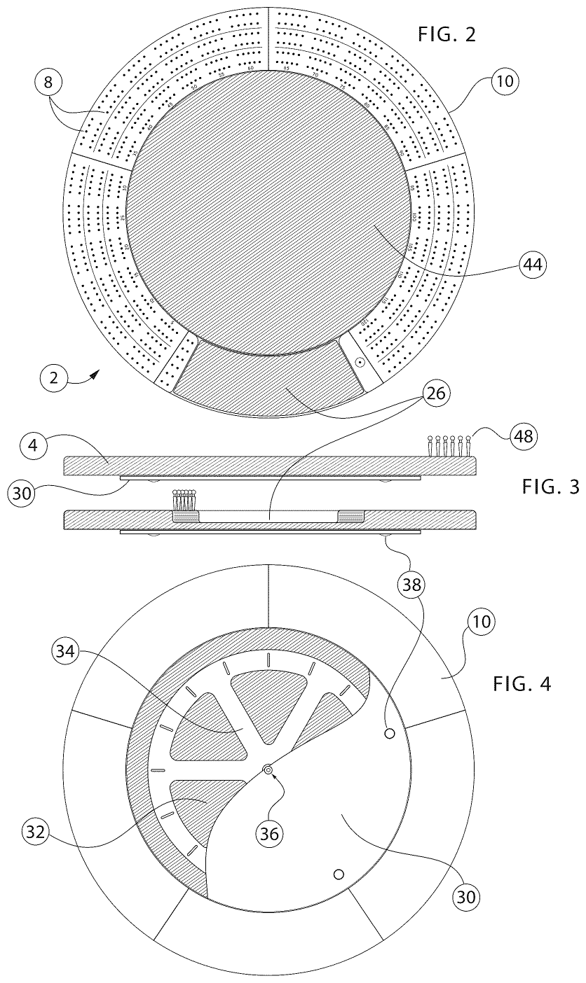

The pegging ring 4 has pairs of parallel pegging hole tracks 8 that mirror the shape of the pegging ring 4. There may be as many as four pairs 8, although only three pairs 8 are illustrated. The minimum number of pairs 8 are one, as would be used for two players or four players playing in teams of two. The pegging ring 4 may be of a one piece construction (FIG. 2) or it may be of a multi piece construction (FIG. 1). When made in a multi piece construction for reduction of storage space, there are several partially circular or arced segments 10 of the pegging ring 4 that have horizontal connection orifices 12 formed therein and mechanically interlocking dowels 14 extending therefrom, that are used to connect the adjacent arced segments 10 to form the complete pegging ring 10. In alternate embodiments there may also be an expansion pegging ring 16 that connects in a similar fashion to a perimeter arc of the pegging ring 10. This allows for additional players beyond the number dictated by the number of pairs of parallel pegging orifice tracks 8 in the board 2.

As seen in FIG. 1, the chosen number of arced segments 10 is five, and four of these five arced segments 10 have three pair of pegging orifice tracks 8 formed thereon. The fifth arced segment 26 connects between the proximal end 20 and the distal end 22 of the partially assembled pegging ring 4 so as to stabilize the open geometric shape. The expansion pegging ring 16 is also made in five arced segments 28, and similar to the pegging ring 4, only one pair of pegging orifice tracks 8 are formed thereon four of the segments. There are 120 orifices per pegging orifice track 8. At the proximal end of the pegging ring 20 three pairs of starting orifices 18 that align and correspond to each of the parallel pegging orifice tracks 8. At the distal end of the pegging ring 22 there is but a single winner orifice 24.

Although discussed using dowels 14 and horizontal connection orifices 12 to connect the segments 10 and 26, there are a plethora of equivalent methods of connection, including but not limited to magnets, latches, dovetailed ends, hooks and the like.

On the pegging ring 4 there are two transverse lines designating the skunk line 60 (at the 90 pegging orifice mark) and the double skunk line 62 (at the 60 pegging orifice mark). These skunk lines 60, 62 may be used for betting enhancement purposes.

The rotatable platter 4 has a planar circular base plate 30 and a rotatable planar circular upper plate 32 with a bearing mechanism 34 affixed there between. (FIGS. 3 and 4) The bearing mechanism 34 may be of several well-known configurations, with a common one seen in the “Lazy Susan” kitchen cabinet. In the preferred embodiment it is a circular planar disk with a set of plain or rotating bearings 40 fixed therein. The top face of the bearing 40 contacts the bottom face of the upper plate 32 and the bottom face of the bearing 40 contacts the top face of the base plate 30. Thus, the bearing plate is held in a low friction spaces configuration in the center of the rotatable platter 4 allowing the pegging ring 4 of the board 2 to rotate in the direction indicated 50 in FIG. 5. The entire rotatable platter 4 is held together by a mechanical fastener 36 that extends through three aligned orifices centrally located on the three plates 30, 32, 34, holding them together and rotationally aligned about their midpoint. There are high friction polymer pads 38 on the bottom face of the base plate 30 to keep it from moving or rotating.

Onto the top face of the upper plate 32 of the platter 6 is attached an elastically deformable substrate 42 such as a foam or rubber carpet underlayment. On top of the deformable substrate 42 is a fabric, preferably a felt 44. There is also curved sections of the deformable substrate 42 and felt 44 that are affixed to the top face of the fifth arced segment 26. The top face of the upper plate 32 (with the deformable substrate 42 and felt 44) is affixed to the pegging ring 4.

Looking at FIG. 5, all of the necessary components of the game CROKER can be seen. This includes the board 2, a deck of 52 playing cards with optional jokers 44, moveable pegs 48, Poker rules 56, Cribbage rules 58, CROKER rules 57 and optional betting chips 46. (Chips 46 bet and thrown into the center of the board are called the pot 99.) The dealt hand 52 minus a discard 54 (four of which form the CRIB) 54 are also illustrated for the purposes of explaining how CROKER is played, herein. (The disclosure herein details play with individuals not teams.)

The game of CROKER has the following steps:
Before explaining in great detail how CROKER is played, the basic steps of the CROKER playing card hybrid game for two or more players, wherein a dealt hand is played twice, are as follows:
dealing each player a hand of five cards from a deck of 52 playing cards;
For the purpose of this description, the play of CROKER will be discussed with four players.
(if playing with two players), then dealing six cards to each of the two players;
discarding two cards from each player's hand to form a CRIB 75;
(if playing with three players) dealing five cards to each of the three players and a single card to the dealer's CRIB;
discarding one card from each of the three players into the CRIB along with the single card to create the standard four card CRIB;
(if playing with four players) dealing five cards to each of the four players.
discarding one card from each player's hand to form a CRIB 75,
eliminating all discarded cards in excess of four from said CRIB (garbage cards) and said game if there are more than four players or four teams; (example, a fifth and sixth player would discard their one card onto the side table, or into the POT area, or on the bottom of the deck. These cards are not in play. The cards may be referred to as discards, junk, or garbage.)
first round betting by players of their Poker hands;
overturning a top shared card from the remaining said deck of 52 playing cards;
second round betting by players of their Poker hands including the top shared card as the fifth card for a completed five card Poker hand;
playing a hand of Cribbage according to a set of the rules of Cribbage, pegging each player's garnered Cribbage points with a pair of pegs in the orifice tracks on a Cribbage configured game board;
counting the dealer's CRIB and pegging dealer's garnered Cribbage points with a dealer's pair of pegs in the orifice tracks on said Cribbage configured game board;
playing a hand of five card Poker according to a set of the rules of Poker with same said cards used in playing said hand of Cribbage, using the dealers CRIB (referred to as the crummy (Poker hand)) to play against every players Poker hand. (If the “crummy” beats everyone, the POT stays and the players who did not stay in have the choice to match the bet to join in the next round of CROKER. (Everyone has to also ante to the existing POT to continue the Poker play.)
collecting Poker hand winnings by winner of said Poker hand;
repeating all previous steps until one player's said pair of pegs reaches a final, 121^{st} Cribbage orifice;
calculating the Cribbage game winner's winnings as 121 minus the number of orifices each player has pegged and multiplying it by a predetermined monetary value;
collecting Cribbage game winnings by winner of said Cribbage game; and
collecting Poker hand winnings by winner of said Poker hand.

The game of CROKER can be played by multiple players playing individually or as teams, from 2 to 8 players. (Note: when playing with only two players, each player must be dealt six cards and must discard 2 cards into the CRIB.) Before play can begin, the following gaming decisions must be made by group consensus or by dealer call: whether to include joker(s); the value of each Cribbage peg orifice; whether a fee from each player is due the Cribbage winner in addition to that determined by the Cribbage orifice spread; the effect if any of the skunk and double skunk lines; the betting rules for Poker; and the player who will be the first dealer.

If Joker(s) is/are introduced, the Cribbage rule states the Joker is always an Ace of any suit. If a player has a joker and the other three cards are of the same suit, the Joker becomes the same suit, and counts as 4 points in Cribbage scoring. In Poker play, the Joker is a wild card.

A determination or agreement of a value can be made as to how much the winner of the Cribbage game collects from each player. And/or an inclusion of peg count from the “finish” hole to the other players front peg. For example, the winner collects $2 from each player for a win; and/or, the winner collects 20 cents for each hole counted from each players last peg placement to the 121^{st} hole. Example, winner collects $2 for the game and $2.80 for a 14 point loss (14×¢20=$2.80) from one player, and collects from others accordingly.

The skunk line, is normally given a two times the value of a win, and a double skunk is normally given four times the value of a win.

A determination is made with all players as to the Poker rules of betting including the creation of a limit as pertained to the maximum bet and how many times a player can raise. A determination if “check and raise” is permitted must also occur. (Check and Raise is a common phrase with players who are knowledgeable in the art of Poker.)

Designation of the first dealer is based on the lowest card cut between all players, Ace being the lowest. Another added value to dealer cut is if two or more players cut the same lowest card, the value of win and/or total peg count doubles in value. This is only a group chose and does not pertain to this invention. Players who mirror in the cut will cut the deck again.

The steps of the playing game are as follows:
a. anteing into the center “collection” area, of the CROKER game board. (The ante is predetermined by the collective players as discussed above.)
b. dealing all players five cards when there are three or more players, where each player discards one card into the dealer's CRIB, or dealing all players six cards in a two player game where each player discards two cards into the dealer's CRIB.
c. (With three players, there is also one card dealt to the dealer's CRIB, and with five to eight players, the first three players to the left of the dealer, including the dealer, discard one card into the dealers CRIB, and the remaining players discard one card out of play. Note: this rule of the fifth to eighth player discarding as “junk” or “garbage” cards is the only one that is not of a standard game rule in Cribbage, since Cribbage is rarely, or never played with more than 4 individual players, unless there are team plays.)
d. determining by each player of which four cards to keep. (The choice will determine if you have a better Poker hand, a better Cribbage hand, or possibly both. Depending on the POT, a player may choose to discard a card that helps the Cribbage hand in favor of a better Poker hand. Or, a good Poker hand may be broken up in favor of a better Cribbage hand. Example, winning the Cribbage game and/or skunking your opponents may be a better game value then focusing on your Poker hand, depending if the POT is worth pursuing.)
e. betting of the first round to check, raise, or fold begins by the players, within the financial limits established previously. (if a player folds, they are out of that Poker round but keep their cards to play Cribbage.)
f. cutting of the deck of remaining cards by the player on the dealer's left or, in a two-player game, the pone, cuts the remaining deck placing the top card of the lower half on top of the reunited deck. If this card is a jack, the dealer scores two points for “heels” or “nibs”. (This “cut” card becomes the common shared Cribbage card in final hand scoring after the playing and laying down of all cards. The “cut” card also becomes the common Poker card.)
g. betting of the second round begins.
h. playing a hand of Cribbage.
i. flipping of the dealer's CRIB by dealer and counting and pegging Cribbage points by dealer.
j. determining the highest Poker hand after the final count of the hand of Cribbage play.
k. using of the dealer's CRIB hand to play against everyone including the dealer, in the Poker game. (This is called a CRUMMY hand, and is unique to this invention.) If the CRUMMY hand is better than the highest Poker hand showing, the POT stays and grows in the game.
   (The players who folded have to match the total bet of those who stayed in to play in the next round. Note: This is an example of how the pot can grow, and alter how a player discards in the next round if they choose to go after the pot with a better Poker hand rather than a better Cribbage hand.)
l. repeating the steps above with the dealer becoming the person to the immediate left of the previous dealer.
m. concluding the game after one player's peg reaches the 121^{st} pegging orifice. If the CRUMMY hand wins, then the pot stays, the group has to choose whether to leave the POT as is and play another round of CROKER, or simply divide up the pot and depart.
n. The Cribbage betting points are counted, calculated and paid to the Cribbage winner.

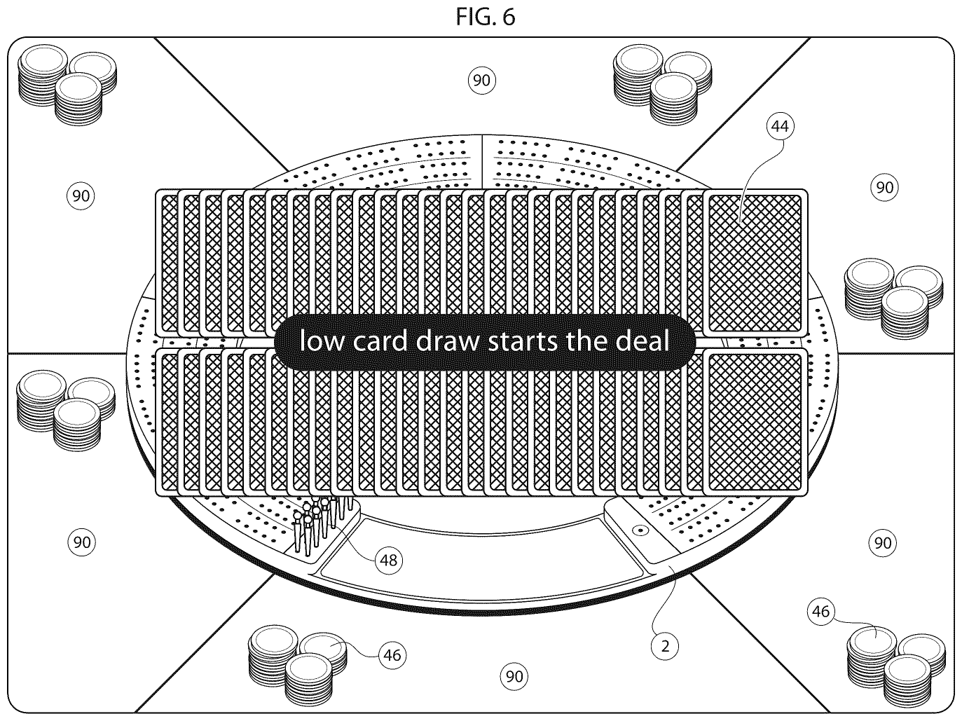

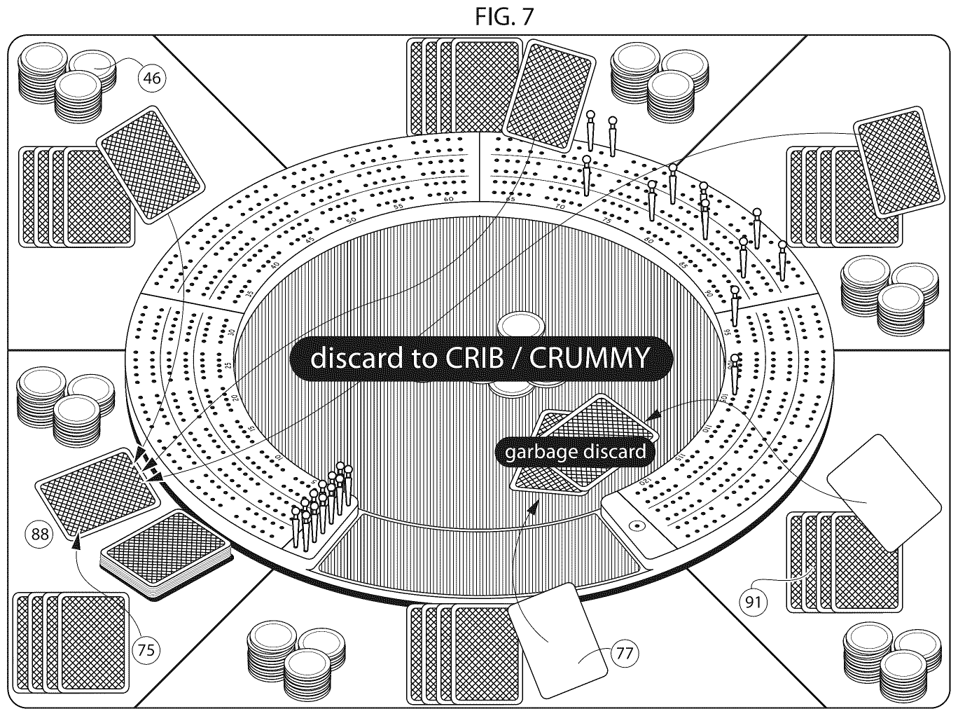

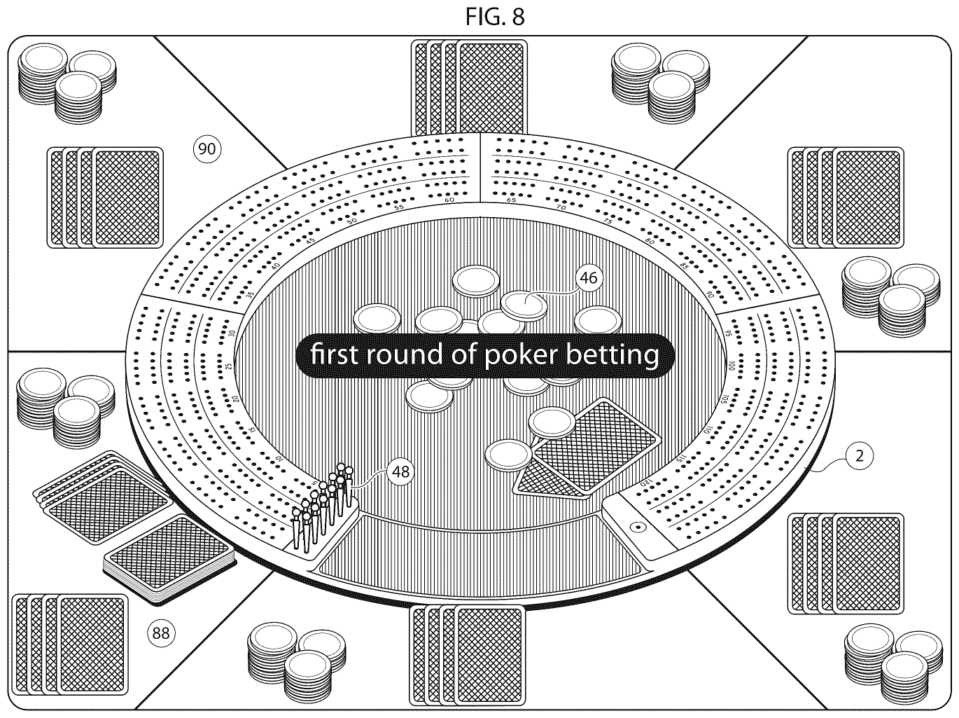

Looking at FIGS. 6 to 14 chronologic snapshot views of a CROKER game being played are illustrated for the purposes of explaining how this hybrid card and board game is played in light of the previous steps. Both of the card games are still played according to established published rules, except with more than four players the “junk” or “garbage” card rule is invoked, and the dealer's CRIB is used as an additional hand against all players in the Poker game to determine the disposition of the Poker POT.

Since there are multiple types of five card Poker each with player selectable options, the players will have to elect the type of five card Poker (here for the purposes of discussion the Poker selected will be five card high hand Poker), as well as the betting parameters and the value of Cribbage points and whether the skunk line/double skunk line on the board have any effect on the value of the Cribbage points. In some circumstances, players can “team up” with another player, to share a pegging track.

FIGS. 6 to 14 show diagrammatic representations of the CROKER game at sequential stages of the game.

FIG. 6 illustrates the beginning of a game of CROKER. There are six players 90 arranged in a circle about the CROKER board 2 and all players pairs of Cribbage pegs 48 are in the starting pegging orifices. The six players 90 each draw a card from the complete deck 44.

FIG. 7 shows that the dealer 88 has been determined by the low card, and sits at the seven o'clock position. Five cards (dealt hand 91) have been dealt to each of the six players 90. The dealer 88 and first three players 90 to the dealer's left discard one card each into the CRIB 75. The remaining two players discard one garbage card 77 each from the game. The four remaining cards in each player's hand is the playing hand 87.

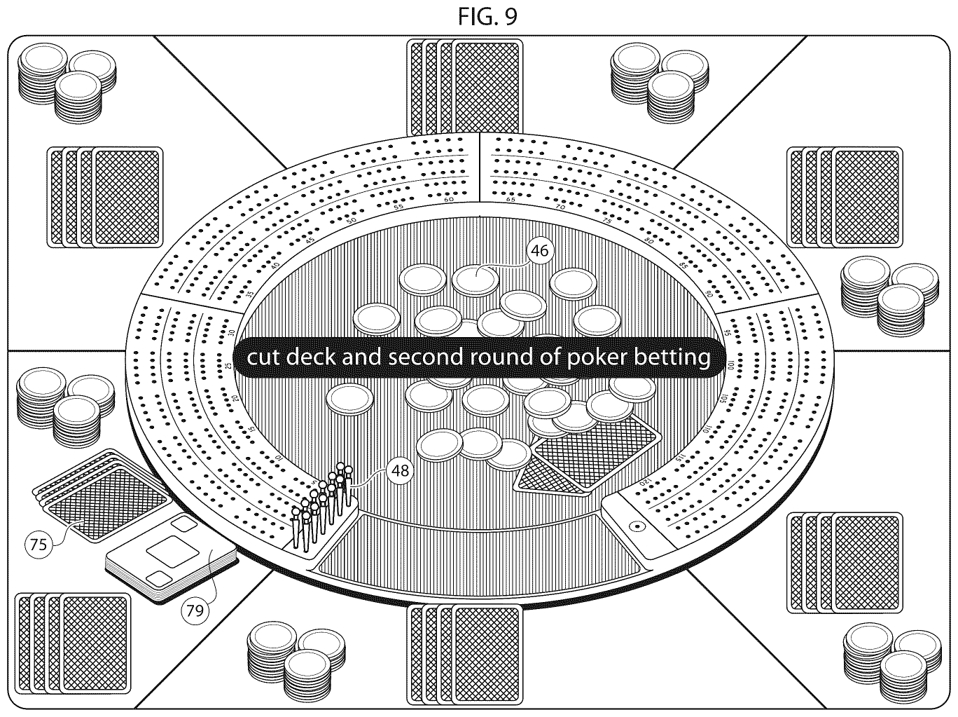

FIG. 8 shows the first round of Poker betting has begun with players tossing their ante and bet chips 46 into the center of the CROKER board 2.

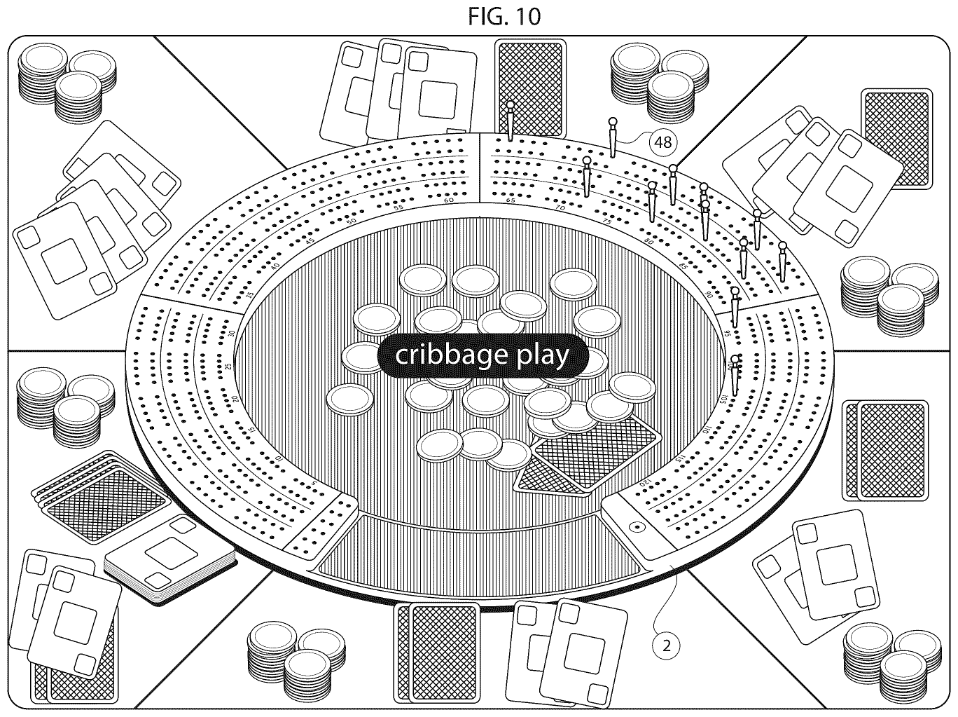

FIG. 9 shows the remaining deck of cards has been cut and the top card from the deck's bottom half has been overturned to become the common Cribbage card 79. The second round of Poker betting has begun.

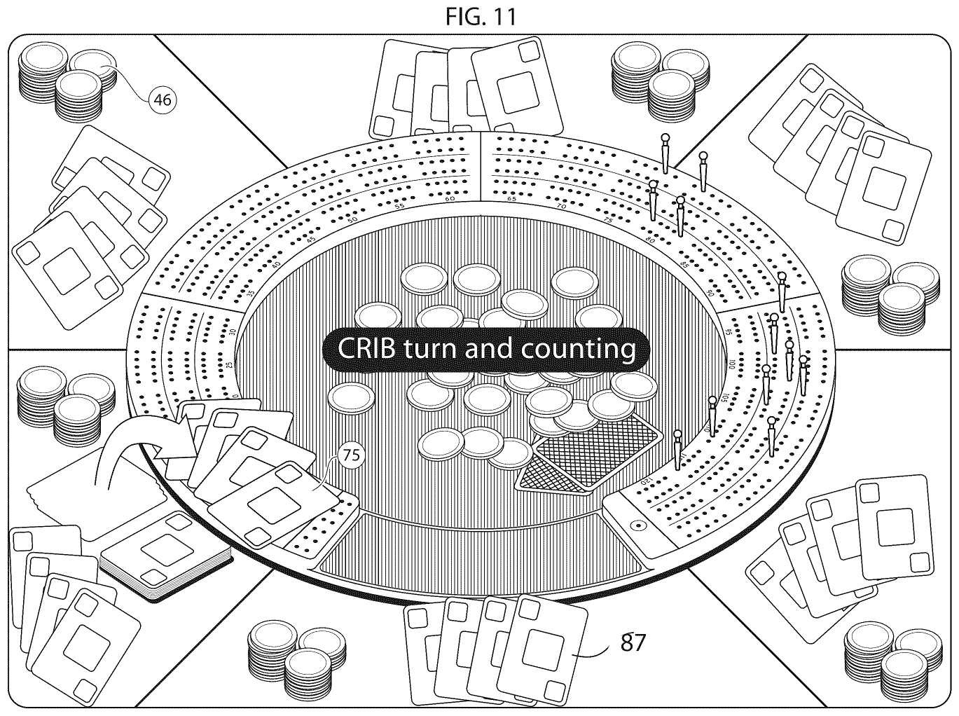

FIG. 10 shows the second round of Poker betting is finished and the Cribbage game has begun with player's pegs 48 moved around the CROKER board 2.

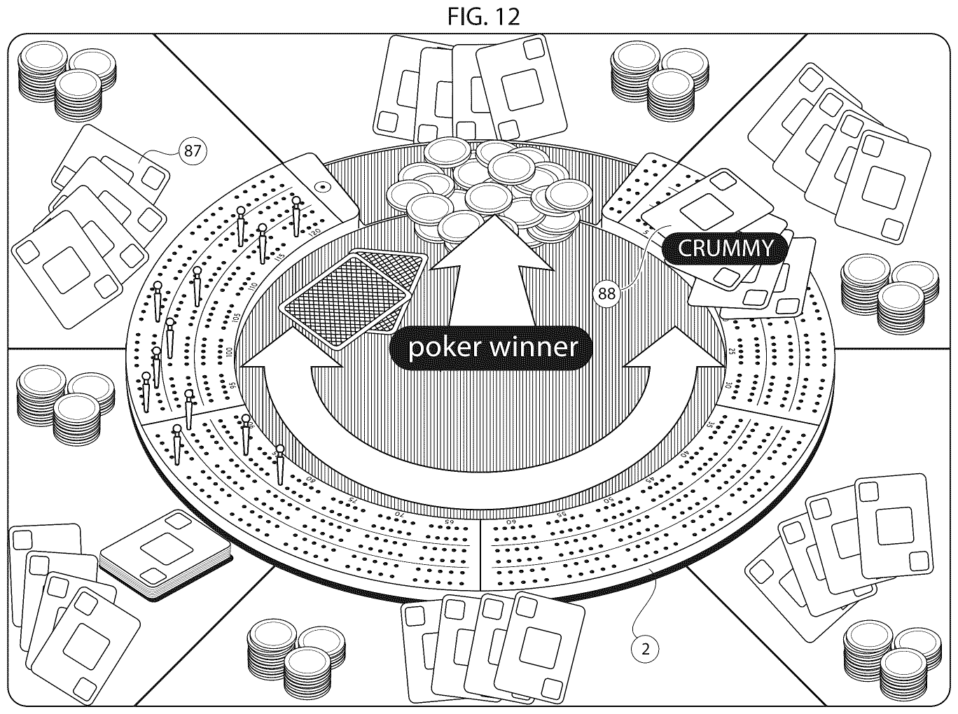

FIG. 11 shows the Cribbage hand has been played and the pegging by all players has been completed for this hand, and the dealer has flipped, counted and pegged their CRIB 75 points.

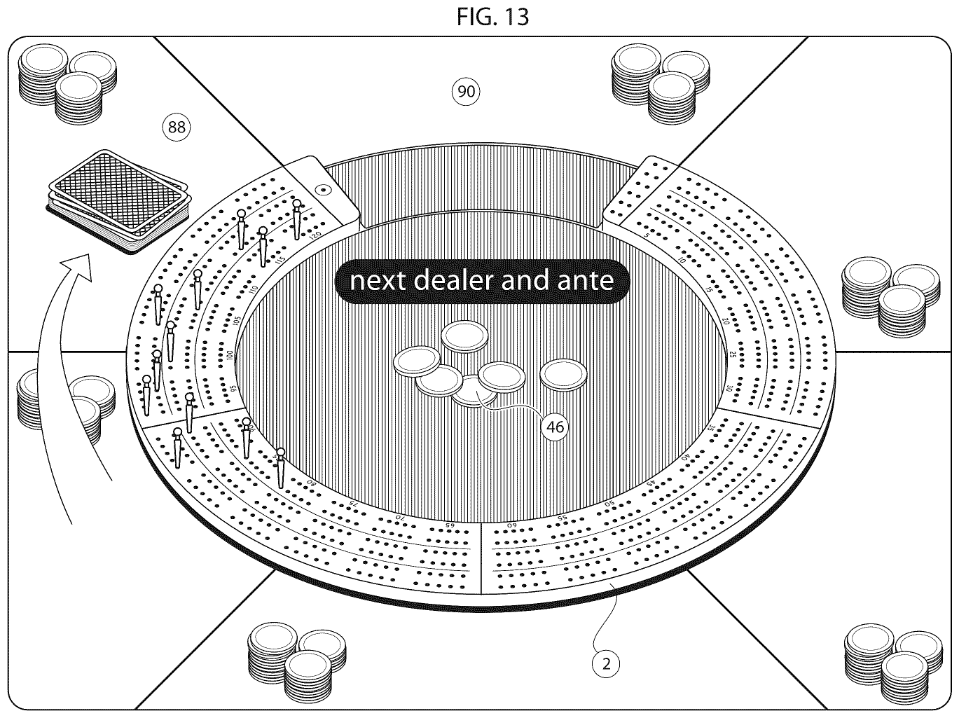

FIG. 12 shows the CRIB 75 now becomes the CRUMMY or the extra hand for the Poker game and a winner is established for the Poker game. Here the CRUMMY was not the best Poker hand, so the Poker pot was distributed to the player with the best hand. The CROKER board has been rotated to place the opening in front of the winner located at the 12 o'clock position.

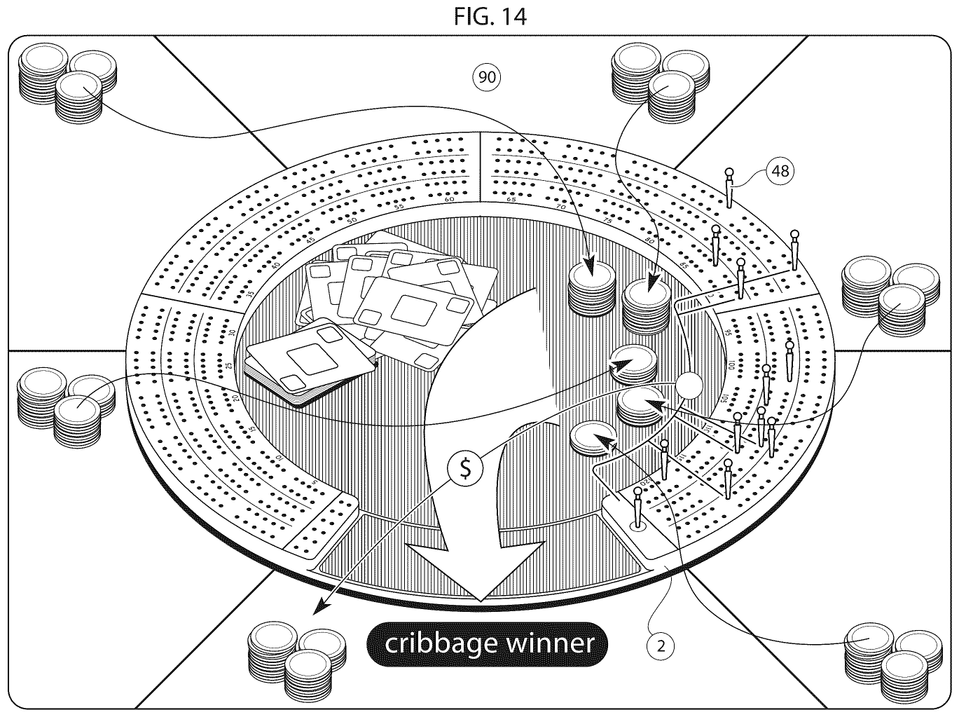

FIG. 13 shows the next hand of the CROKER game begins and the dealer has now moved to the left of the previous dealer, who is located at the 10 o'clock position. The Poker ante has been placed by all players into the center of the CROKER board 2. From this point forward, the previous steps are now repeated for another hand.

FIG. 14 shows the completion of the Cribbage game as one of the player's pegs 48 has reached the 121^{st} hole in the board and they have won the Cribbage game. The Cribbage pot is calculated looking at the other player's locations on the board and the non-winning players put their Cribbage losses chips 46 into the center of the CROKER board 2 for the Cribbage winner to collect. The winner of the last Poker hand collects his winnings. The CROKER game has ended.

While certain features and aspects have been described with respect to exemplary embodiments, one skilled in the art will recognize that numerous modifications are possible. Moreover, while the design of the CROKER game board as well as the steps of playing CROKER as described herein are described in a particular order for ease of description, unless the context dictates otherwise, various steps may be reordered, added, and/or omitted in accordance with various embodiments. Hence, while various embodiments are described with—or without—certain features for ease of description and to illustrate exemplary aspects of those embodiments, the various components and/or features described herein with respect to a particular embodiment of CROKER can be substituted, added, and/or subtracted from among other described embodiments, unless the context dictates otherwise. Consequently, although several exemplary embodiments (especially of the CROKER game board) are described above, it will be appreciated that the invention is intended to cover all modifications and equivalents within the scope of the following claims.

Having described and illustrated the principles of the inventive concept with reference to illustrated embodiments, it will be recognized that the illustrated embodiments can be modified in arrangement and detail without departing from such principles, and can be combined in any desired manner. And although the foregoing discussion has focused on particular embodiments, other configurations are contemplated

Consequently, in view of the wide variety of permutations to the embodiments described herein, this detailed description and accompanying material is intended to be illustrative only, and should not be taken as limiting the scope of the inventive concept. What is claimed as the invention, therefore, is all such modifications as may come within the scope and spirit of the following claims and equivalents thereto.

Having thus described the invention, what is claimed as new and desired to be secured by Letters Patent is as follows:

1. A playing card hybrid game for two to eight players, that follows the rules of both poker and cribbage, comprising of the steps of:
obtaining a deck of playing cards, a game board with at least two pair of pegging orifices formed therein, and at least four pegs sized for engagement with said pegging orifices;
dealing each player a minimum of five cards from said deck of playing cards;
discarding at least one of said playing cards to make a crib hand and to make a playing hand;
eliminating all cards in excess of four from said crib hand;
cutting said deck of playing cards and displaying an overturned top card from a bottom half of cut said deck of paying cards;
playing a hand of five card poker with an outcome decided as per a set of five card Poker rules;
utilizing said same hand to advance a pair of pegs about said game board in accordance with the outcome of played cribbage hands, said counting of crib hands and said top cards, played in accordance with a set of Cribbage rules.

2. The playing card hybrid game of claim 1 wherein the number of players is two and the number of said playing cards dealt is six and the number of said playing cards discarded to said crib is two.

3. The playing card hybrid game of claim 1 wherein the number of players is four and the number of said playing cards dealt is five and the number of said playing cards discarded to said crib is one.

4. The playing card hybrid game of claim 1 wherein the number of players is six and the number of said playing cards dealt is five and the number of said playing cards discarded to said crib is one.

5. A playing card hybrid game between poker and cribbage, wherein a dealt hand is played twice, comprising the steps of:
determining the first dealer by a cutting of said cards for low card;
dealing each player a hand of at least five cards from a deck of 52 playing cards;
discarding at least one card from each player's said hand to form a dealer's crib,
eliminating all discarded cards in excess of four from said dealer's crib and said game;
betting of first round by players of their poker hands;
cutting the deck of cards and displaying a top card from the top of the bottom half of said deck;
betting of a second round of their poker hands by players which include the top card as a common shared poker card;
playing a hand of five card poker according to a set of the rules of poker, said dealer's crib used as another poker hand played against all players;
playing a hand of cribbage according to a set of the rules of cribbage using same said cards used in playing said hand of poker;
pegging each player's garnered cribbage points with a pair of pegs in the orifice tracks on a cribbage configured game board;
collecting poker hand winnings by winner of said poker hand;
repeating all previous steps until one player's said pair of pegs reaches a final, 121^{st} cribbage orifice;
calculating the cribbage game winner's winnings as 121 minus the number of orifices each player has pegged and multiplying it by a predetermined monetary value;
collecting cribbage game winnings by winner of said cribbage game; and
collecting poker hand winnings by winner of last said poker hand.

6. The playing card hybrid game of claim 5 wherein the number of players is two and the number of said playing cards dealt is six and the number of said playing cards discarded to said crib is two.

7. The playing card hybrid game of claim 5 wherein the number of players is four and the number of said playing cards dealt is five and the number of said playing cards discarded to said crib is one.

8. The playing card hybrid game of claim 5 wherein the number of players is six and the number of said playing cards dealt is five and the number of said playing cards discarded to said crib is one.
